(19) United States
(12) Patent Application Publication
(10) Pub. No.: US 2005/0010484 A1
(43) Pub. Date: Jan. 13, 2005

(54) Apparatus for and method of facilitating fulfillment of buyer's/seller's desire

(76) Inventors: Scott Bohannon, Alexandria, VA (US); Robert M. Fisher, Alexandria, VA (US); Joel Whitaker, Washington, DC (US)

Correspondence Address: DICKSTEIN SHAPIRO MORIN & OSHINSKY LLP, 2101 L Street, NW, Washington, DC, 20037, US

(21) Appl. No.: 10/616,924

(22) Filed: Jul. 11, 2003

(51) Int. Cl. G06F 17/60

(52) U.S. Cl. 705/26

(57) ABSTRACT

A system and method is provided for facilitating fulfillment of a buyer's desire to purchase products or services, and a seller's desire to sell products or services. In a preferred embodiment, a system allows a buyer to make a search query by entering a description of certain products or services desired to be purchased. A host server receives the search query via a network (e.g., the Internet), processes the search query utilizing a search engine to search data stored in databases, and returns a list of items relevant to the search query, including items matching the buyer's desire, items that are alternatives to the buyer's desire, items that are statistically relevant to the buyer's desire, items that are informational source that may be useful in fulfilling the buyer's desire, and items that are targeted advertisements selected based on the buyer's desire (or a profile of the buyer).

### BACKGROUND OF THE INVENTION

The widespread use of global electronic networks has revolutionized the way buyers and sellers of goods and services interact, exchange information and conduct business. The Internet, for example, removes geographic boundaries and permits seamless and instantaneous exchange of information. However, navigating the web of information has presented a formidable challenge. Some consumers hesitate to enter the world of electronic commerce due to the lack of an easily navigable system that provides relevant information necessary to make an informed purchase decision. Often, the buyer has only a vague idea of a good or service they desire. Vague notions of a purchase desire are essentially useless when attempting to locate the needle in the haystack of the Internet. Access to cellular phones, personal digital assistants (PDAs) and other handheld computer devices have expanded the reach of the global electronic network. In addition, consumers without immediate access to a desktop or laptop personal computer also desire current and relevant information regarding the price, features and availability of goods and services. The widespread availability of electronic information has only added to the problems of navigability and “information overload.”

Current comparison shopper sites such as MySimon.com, BottomDollar.com, and PriceSearch.com permit buyers to obtain information about various products. These sites focus overwhelmingly on consumer products that are easily differentiated (electronics, books, CDs, appliances) and require no negotiation over configuration. Keyword searches cull through a subset of online retailers for putative matches and present results sorted by price; buyers can also browse by category. Keywords will often generate results completely unrelated to a buyer's request. On some sites, buyers may also compare a limited set of product characteristics, depending on the product type in question. Buyers may ultimately connect directly to the retailer's site to make a purchase. The comparison shopping sites receive revenue based on a combination of advertising revenue and transaction fees. MySimon, for example, charges between two and five percent per transaction depending on whether the visitor makes a purchase or merely visits the seller site.

Reverse auction Web sites such as Priceline.com are vehicles for enabling companies to clear surplus inventory at reduced prices without selling them through regular channels and affecting market rates. Sellers profit from capacity that would have remained unsold, and buyers pay below-market prices. The current reverse auction Web sites require the buyer to make a conditional offer to potential sellers. The sellers may optionally accept or decline the conditional offers.

Internet sites such as BizBuyer, OnVia, and BuyerZone are directed to the business-to-business (B2B) market and provide goods and services directed to the business community. These sites facilitate a small-business version of reverse auction, which requires buyers to fill out a formal request for quote (RFQ), which is then sent to sellers who bid on the business. Typical products include computer equipment and office supplies; services include marketing, recruiting, technical support and shipping services.

### SUMMARY OF THE INVENTION

A system (and corresponding method) is provided for facilitating fulfillment of a buyer's desire to purchase products or services, and a seller's desire to sell products or services. In accordance with a preferred embodiment, a system is used to allow a buyer to effectuate a search query by entering a description of certain products or services desired to be purchased. A host server receives the search query via a network (e.g., the Internet), processes the search query utilizing a search engine to search data stored in databases, and returns a list of items relevant to the search query.

The host server produces a results list of items related to the buyer's desire, including items matching the buyer's desire, items that are alternatives to the buyer's desire, items that are statistically relevant to the buyer's desire, items that are an informational source that may be useful in fulfilling the buyer's desire, and items that are targeted advertisements selected based on the buyer's desire (or a profile of the buyer). The list of items returned to the buyer includes: the name of relevant products/services, descriptive information on the product/service, the name and contact information of the seller of the listed product/service, as well as any information on the terms or conditions of sale for the product/service.

The system also permits seller's to effectuate a search query of their own to effectuate a search for potential buyers of products or services which the seller has to offer. The seller initiates the search by entering a description of the products/services it has to offer and transmitting the description to the host server. The host server initiates a search of buyer's desires (currently or previously) entered into the system based on the seller's search query. The results of the search are returned to the seller, and in some embodiments, returned to the buyers associated with the buyer's desires found relevant to the seller's query.

### BRIEF DESCRIPTION OF THE DRAWINGS

Many advantages, features, and applications of the invention will be apparent from the following detailed description of the invention that is provided in connection with the accompanying drawings in which:

FIG. 1 is a block diagram illustrating a system in accordance with a preferred embodiment of the invention;

FIG. 2 is a block diagram illustrating a search engine in accordance with a preferred embodiment of the invention;

FIG. 3 is a block diagram illustrating the use of database structures in accordance with a preferred embodiment of the invention;

FIG. 4 is a block diagram illustrating a processor-based system in accordance with a preferred embodiment of the invention;

FIG. 5 is a flowchart illustrating processing of a buyer's desire in accordance with a preferred embodiment of the invention;

FIG. 6 is a flowchart illustrating processing of a seller's desire in accordance with a preferred embodiment of the invention; and

FIGS. 7-11 are flowcharts illustrating processing of a buyer's desire in exemplary implementations of the invention.

### DETAILED DESCRIPTION OF THE INVENTION

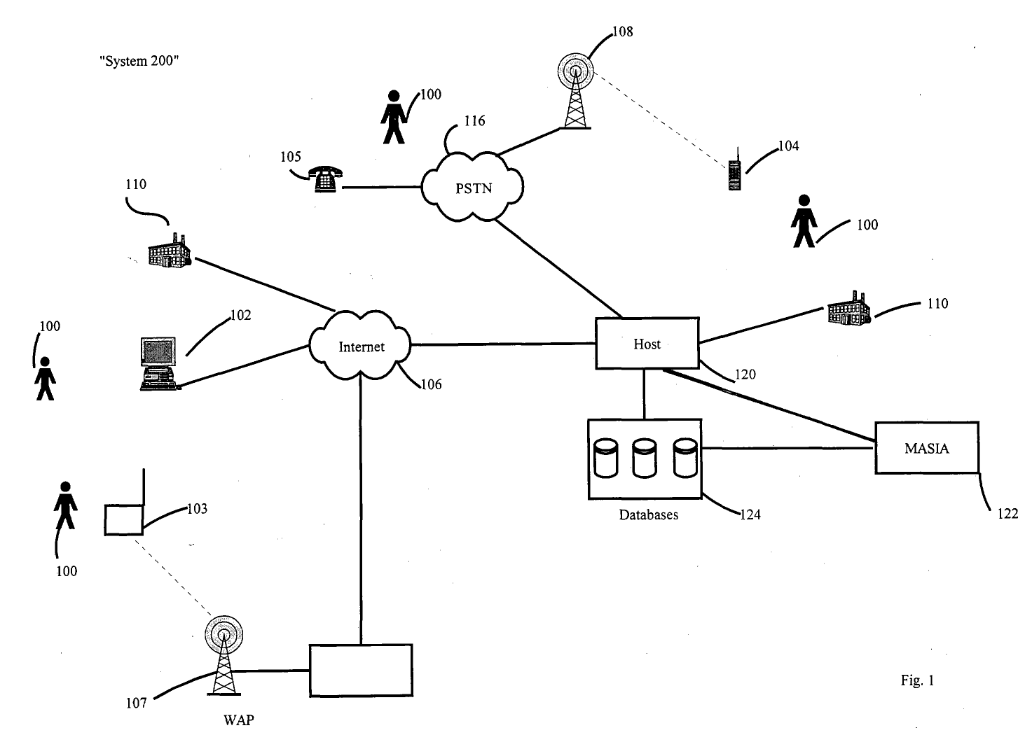

Preferred embodiments and applications of the invention will be described below in connection with FIGS. 1-11. Other embodiments may be realized and structural or logical changes may be made to the embodiments without departing from the spirit or scope of the invention. Although the preferred embodiments disclosed herein have been particularly described as applied to a system for fulfilling desires of buyers and sellers in conjunction with one or more Web sites over the Internet, it should be readily apparent that the invention may be embodied to provide services to other systems over other communications networks having the same or similar problems.

In accordance with a preferred embodiment of the invention, an apparatus for (and a corresponding method of) fulfilling a buyer's desire to purchase products or services, and a seller's desire to sell products or services is provided. As shown in FIG. 1, a purchase request system 200 is provided to facilitate the entry by one or more buyers 100 (e.g., individual consumers, businesses, government entities, etc.) of information or data representative of needs or desires for products or services. These products and services are to be provided by one or more sellers 110 (e.g., individuals, retailers, e-tailers, wholesalers, distributors, manufacturers, etc.). System 200 provides a variety of user interfaces to allow buyers 100 (as well as sellers 110) to enter information into (and obtain information from) system 200.

For example, buyers 100 may be supplied with a user interface in the form of a computer terminal 102. (The computer terminal 102 symbolically represents any known communication device for connecting to a computer network or like information system.) The computer terminal 102 is shown coupled to a network 106, which, for illustration purposes, is the Internet in this preferred embodiment. (Any known network or communication system (e.g., intranet, extranet, local area network (LAN), wide area network (WAN), BBS, instant messaging network, etc.) may be used in lieu of or in combination with the Internet, however.) Any type (or number) of user interface mechanism providing an interface for a user (e.g., buyer 100, seller 110) to network 106 may be used. In FIG. 1, for example, a user interface 103 takes the form of a communication device (e.g., wireless telephone, personal digital assistant (PDA), paging device, etc.) operating the wireless access protocol (WAP) in conjunction with a WAP-enabled wireless carrier 107.

Additional user interfaces may be used to interface a user (e.g., buyer 100, seller 110) with host server 120 directly, or indirectly through another network (e.g., public switched telephone network (PSTN)). In making the connection with host server 120 through PSTN 116, a number of different interface devices may be used such as landline telephones 105, or wireless telephones 104 (through one or more wireless carriers 108). For clarity purposes, user interfaces in use by sellers 110 are not illustrated in FIG. 1. It should be readily apparent, however, that any user interface (e.g., those described herein for buyer 100) may be used by sellers 110 without departing from the scope of the invention.

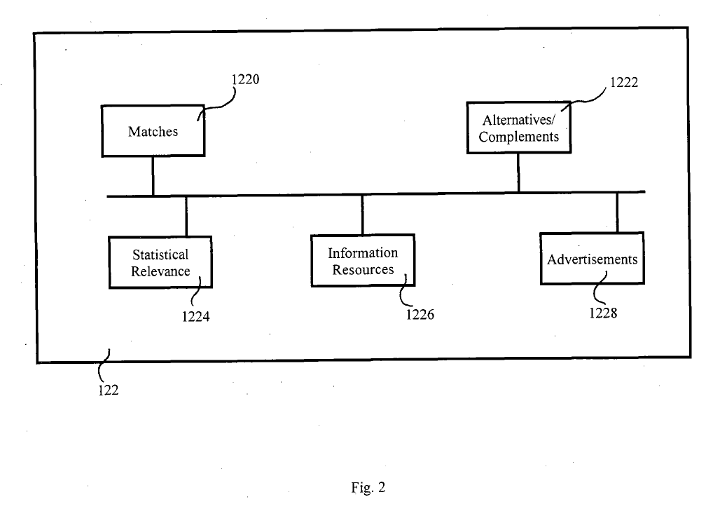

As will be apparent from the description below, host server 120 operates in conjunction with search engine 122 and databases 124 to process information and data regarding desires (from buyers 100 and sellers 110), and facilitate the fulfillment of the desires through system 200. In the illustrated embodiment, search engine 122 implements a suite of search modules or applications referred to herein as “MASIA (as shown in FIG. 2): Matches 1220; Alternatives/complements 1222; Statistical relevance 1224; Information resources 1226; and Advertisements 1228. MASIA 122 executes search queries on one or more (local or remote) databases (symbolically represented in FIG. 1 as databases 124) and returns the query results through one or more user interfaces 102, 103, 104, 105. These various modules 1220, 1222, 1224, 1226, 1228 operate together to process an input query.

To illustrate, an exemplary input query is transmitted from a buyer through a user interface (e.g., 102) and forwarded to MASIA 122 (e.g., through Internet 106 and host server 120). In response to the request, MASIA 122 searches databases 124 using modules 1220, 1222, 1224, 1226, 1228, and returns a variety of information pertinent to the search query. Matches Module 1220, for example, is used to analyze the buyer's search query (e.g., the description entered by the buyer of a desired product or service), and then search databases 124 for sufficiently similar products/services. Matches Module 1220 preferably returns to the requesting buyer a list of the matching items along with information such as a description of each listed item, including audio/visual information corresponding to the item, and the name and contact information of the seller offering the listed item, or other relevant information.

Alternatives/Complements Module 1222 analyzes the same search query and performs searches of databases 124 for complementary and substitute items. Preferably, those items already identified by Matches Module 1220 are removed from the results output from Alternatives/Complements Module 1222. Alternatives/Complements Module 1222 then returns to the requesting buyer a list of the complementary and substitute items along with the same type of relevant information provided by Matches Module 1220.

Statistical Relevance Module 1224 analyzes the same buyer's search request and then searches databases 124 for items identified as statistically likely to be desired by the buyer based on the search request. The statistical analysis performed by Statistical Relevance Module 1224 may, for example, take into account items identified by sellers as being desired in connection with the same or similar search requests, or based on historical data of prior purchases by the same or similar buyers. Statistical Relevance Module 1224 preferably eliminates those items identified in Matches Module 1220 and Alternatives/Complements Module 1222. Statistical Relevance Module 1224 returns to the requesting buyer a list of relevant items along with the same type of relevant information provided by Matches Module 1220.

Information Resources Module 1226 preferably analyzes the same buyer's search request and then searches databases 124 to identify Web sites (and/or other Internet-based or non-Internet-based resources) that provide information that may help the buyer fulfill its desire. Information Resource Module 1226 preferably returns to the requesting buyer a list of resources with potential helpful information.

Advertisement Selection Module 1228 analyzes the same search query (and/or any information identifying the buyer) and then identifies corresponding targeted advertising based on advertiser specified criteria. The module preferably returns to the requesting buyer the targeted advertisement information.

Each module 1220, 1222, 1224, 1226, 1228 of MASIA 122 thus contributes information that is (typically) passed to host server 120 on route to one or more user interfaces for display (or other output) by the requesting buyer. The information and data facilitates the fulfillment of the expressed desire of the buyer and may include (i) a product or service name; (ii) a description of the product or service, including audio/visual information; (iii) the name of each seller; (iv) seller contact information such as a link to the seller's Internet site, phone number, e-mail address, etc.; and (v) and sales information such as price, quantity, quality, warranty, delivery, etc.

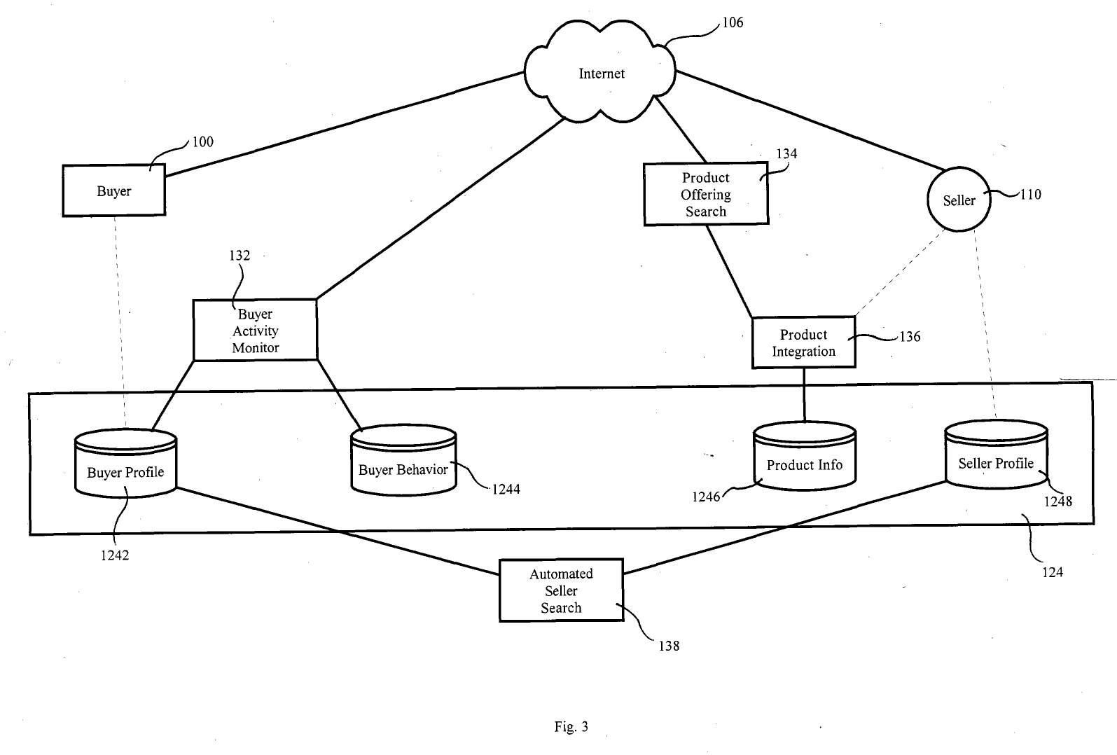

In a preferred embodiment of the invention, one or more database structures make up the collection of databases 124 illustrated in FIG. 1. As is well known in the art, the database structures may be physically connected within the same location, or have one or more structures remotely located in different locations. In the embodiment illustrated in FIG. 3, databases 124 include buyer profile database 1242, buyer behavior database 1244, product information database 1246, and seller profile database 1248. Buyer and seller profile databases 1242, 1248 store identifying information regarding the buyers and sellers, respectively, such as one or more of the following: contact name, address, telephone number, fax number, e-mail address, preferences, user registration ID/password, payment options, interest information, etc. Search queries and/or results may also be stored in the profile databases, as associated with the respective buyer 100 or seller 110. In some cases, buyer profile database 1242 may be limited to generic (or anonymous) information that characterizes the buyer rather than referencing the actual identity of the individual buyer. In many cases seller profile database 1248, however, will provide the actual identity of the seller so that buyers can contact the sellers to fulfill their desires. Both buyer and seller profile databases 1242, 1248 may receive information for storage through respective direct connections to buyer 100, seller 110, or through one or more indirect connections (e.g., Internet 106).

Information and data (text, icons, audio, visual, links, etc.) on products and services available from sellers 110 (or other sources) is stored in product information database 1246. A buyer behavior database 1244 stores information on buyer activity (e.g., shopping activity) that can be used to provide statistical data used, for example, in target advertising and determining statistical relevance. Preferably, some or all search queries (e.g., desired product description) entered into the system are stored in this database. As an alternative, specific queries associated with particular buyers may be stored in the buyer profile database 1242.

In addition to (or as part of) the access to databases 124 by MASIA search engine 122, additional modules or applications are provided with direct (or indirect) access to databases 124, such modules including buyer activity monitor 132, product offering search module 134, product integration module 136, and automated seller search module 138. Buyer activity monitor 132 is operative to track the use made of system 200 by buyers 100. Search requests, purchases, visits to Web sites, and other interaction made of system 200 are monitored and sent to buyer profile database 1242 and/or buyer behavior database 1244 for storage. The activity information may also be exported to additional components of system 200 (e.g., Statistical relevance module 1224, Advertisement module 1228, etc.) or to components outside of system 200.

Product offering search module 134 is used to search and retrieve from Internet 106 (or any other accessible resource) information and data relevant to products or services offered in the marketplace. The module may access designated resources (e.g., specific Web sites), search offerings by designated or profiled sellers, search offerings for designated or profiled buyers, search offerings regarding designated or profiled goods or services, etc. Information and data retrieved by product offering search module 134 are stored in databases 124, preferably in product information database 1246.

Product integration module 136 operates to format information and data regarding products or services to be stored in product information database 1246. Such information is typically retrieved during a search from product offering search module 134, or downloaded/uploaded directly from seller 110 (or its Web site).

Automated seller search module 138 executes searches of product descriptions (or other search queries). Preferably, the module operates on data stored in buyer profile database 1242 based on search criteria stored in seller profile database 1248. A buyer electing to save a search query (representing a buyer's particular desire) may permit the queries to be manually searched by sellers 110 or through automated seller search module 138. Automated seller search module 138 preferably utilizes the search functions provided by MASIA 122, but may use (in lieu of, or in combination with MASIA) its own searching mechanism to provide a list of buyer's desires relevant to the search criteria input by the seller (or stored in seller profile database 1248). The results of the search are stored or output to seller 110. For each item in the results, for example, automated seller search module 138 may return: the relevant item and degree of relevance (e.g., match, complement, substitute, etc.); the corresponding desire description (or other search query information); the mechanism for contacting the buyer; and other information requested by the seller (e.g., the lowest identified item and price, etc.).

In accordance with a preferred embodiment, individual buyers identified in the results of the seller's search may also be notified of the search results. If desired, the buyer can be notified directly by system 200 or by seller 110. The results may also be stored (e.g., in buyer profile database 1242 along with the search buyer's desire query) for later retrieval by the buyer. In accordance with a preferred embodiment of the invention, standard information (e.g., product descriptions, promotional materials, conditional/unconditional offers for sale, etc.) can be automatically forwarded to (or stored for later retrieval by) any or all of the buyer's associated with desires resulting from the seller search.

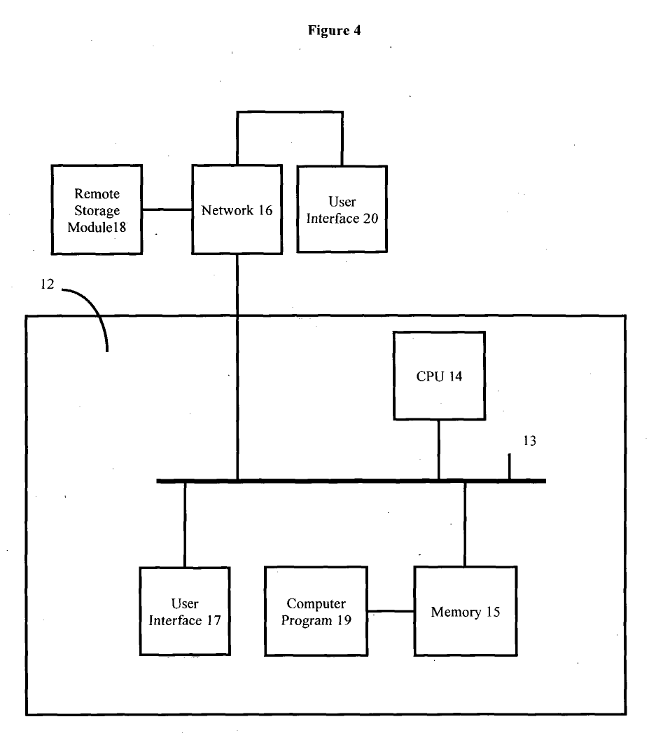

In accordance with a preferred embodiment of the invention, a processor-based system 12, as shown in FIG. 4, is used to implement one or more of the subsystems used in system 200, including host server 120, MASIA search engine 122, databases 124, and modules 132, 134, 136, 138. Preferably, one or more of the processor-based system components are coupled together using bus 13 (although alternative (wired or wireless) connection schemes known in the art may also be used). As shown, at least one processor (symbolically represented by central processing unit (CPU) 14) is provided for execution of one or more computer programs 19 stored on any (one or more) known recording mediums (symbolically represented as memory 15 and remote storage module 18). CPU 14 performs, controls, or at least informs the various processing steps performed by the system in sending and retrieving data to and from at least one user interface 17 and/or network 16. A user interface 17 may be connected directly to bus 13 or remotely connected (e.g., as shown by user interface 20) through network 16 (e.g., Internet 106). Network 16 represents (wired or wireless) connection of two or more devices, directly or indirectly connected (e.g., directly coupling through cable, indirect coupling through one or more hubs or servers, whether network 16 is local to processor-based system 12, geographically remote from system 12, or a distributed combination of local/remote network components).

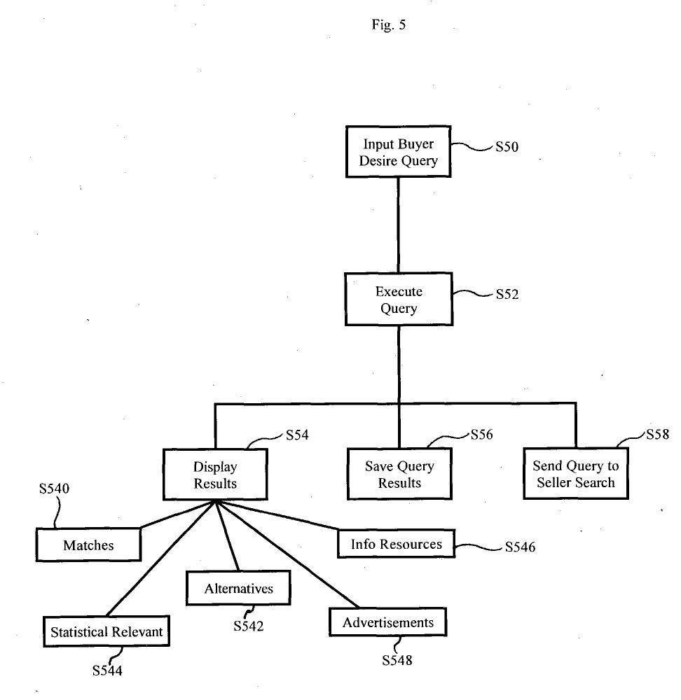

System 200, as thus described and depicted in FIG. 1, may be used, in accordance with a preferred embodiment of the invention, to facilitate fulfillment of a buyer's desire through execution of the acts illustrated in FIG. 5. During an initial step (S50), a buyer 100 enters a description (or other search query) representative of the buyer's desire for products or services. In a preferred embodiment, the MASIA search engine 122 implements a “natural language” search that permits queries to be entered in the buyer's own words, e.g., answerlogic.com, ask.com, diogene99.com, egain.com, iaskweb.com, kachinanet.com, serviceware.com. The search query is executed by, for example, MASIA 122 performing a search of databases 124 (S52).

After execution of the search query, the results may be returned to buyer 100 for display (S54) through the appropriate network(s) and user interface(s). The results of the query execution (S52) may take on a variety of forms. In a preferred embodiment, a display of the results is produced through direct matches of the query (S540), alternatives or complements of the query (S542), statistical relevance to the query (S544), information resources related to the query (S546), and advertisements related to the query (or buyer entering the query) (S548).

The query itself, as well as the corresponding results may also be saved (S56), for example, in buyer profile database 1242. As a further option, the query can be designated (or sent) for searching by sellers 110 (S58). Sellers 110 may have system 200 perform automatic searches (e.g., using automated seller search module 138 (FIG. 3)) for buyers' desires that are relevant to the products or services provided by the sellers 110. System 200 may also, in accordance with a preferred embodiment of the invention, provide sellers 110 with the ability to perform manual searches of buyers' desires that are stored in a database, or in real-time while buyer desire queries are being entered into the system.

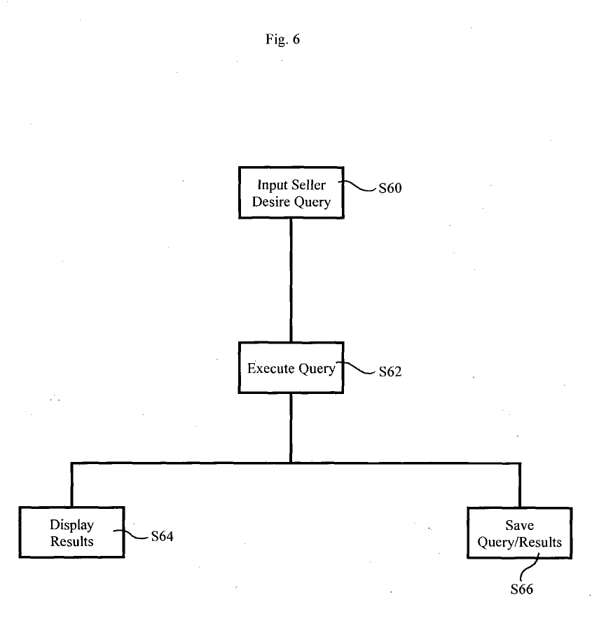

In accordance with a preferred embodiment, a seller 110 has the ability to search buyers' desires to find potential buyers of the seller's products or services. System 200 facilitates the seller's search by performing the acts depicted in FIG. 6. Initially, an input of the seller's query representative of its own desires (e.g., description of the product or service the seller desires to sell to potential buyers) is made (S60). The seller's search query is executed (S62) to produce a list of relevant buyer desires from all of the buyer desires previously stored in the system (e.g., in buyer profile database 1242). The resulting list can then be displayed (S64) in a manner similar to that used in step S54 (FIG. 5). The query itself, as well as the results can also be saved (S66) to a storage medium. In accordance with a preferred embodiment, the execution of the query (S62) may be performed in real-time to search buyer desires as they are input into system 200. The execution of the seller's query (S62) may also be performed automatically using automated seller search module 138 (FIG. 3) or other like device. Automated seller search module 138 retrieves predetermined search criteria from storage (e.g., seller profile database 1248), and automatically executes the search on stored buyer desires (or on buyer desires entered into the system in real-time).

For further illustration of the invention, examples of different implementations of the invention are provided below. Any one or more of the embodiments described above (as well as any number of alternative embodiments not disclosed herein) may be used to reduce the following examples to practice in accordance with the invention. In the examples, the invention is embodied in the operation of a Web site referred to herein as the “BuyersDesire” Web site and its supporting infrastructure. As with many sites, the BuyersDesire host server distinguishes between registered users and new users (or registered users who wish to proceed anonymously). Operation of the Web site is as follows.

### EXAMPLE 1

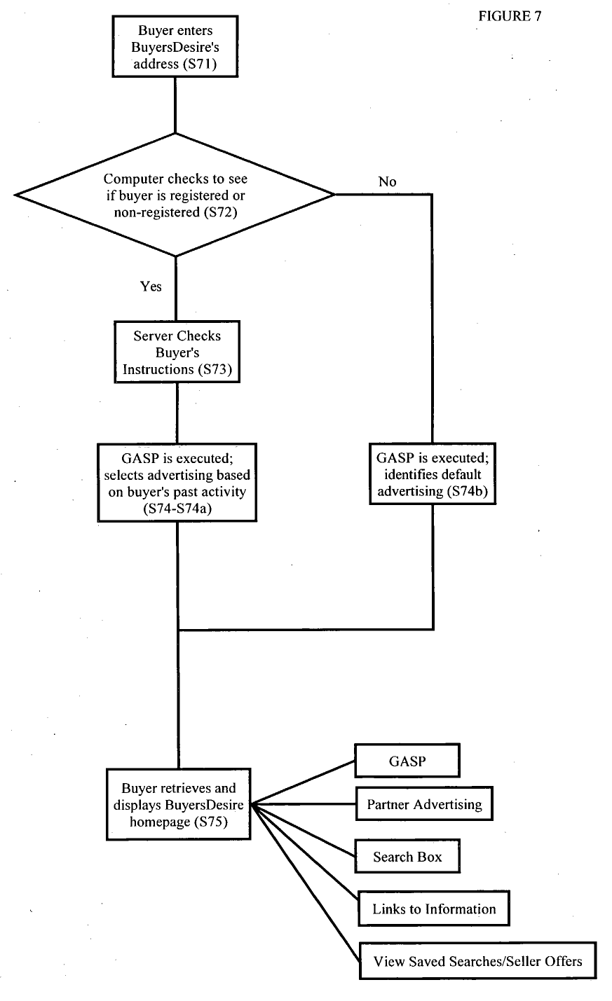

### Buyersdesire Web Site (FIG. 7)

Step 1 (S71). The buyer enter s a web address into the address field on its browser, selects BuyersDesire from its favorites list, activates a link to BuyersDesire on a Web page providing a hyperlink, or otherwise arrives at the Web site. This action opens a session on one of BuyersDesire's servers.

Step 2. (S72) The BuyersDesire host server checks the buyer's client-side computer for a cookie indicating whether or not the buyer is a registered buyer that has chosen to be identified as such during a previous visit.

Step 3. (S73) If the buyer appears to be a registered buyer, then the host server designates the buyer as such for the remainder of the session. The host server also checks to see whether or not the seller has saved searches or seller offers.

Step 4. (S74) The host server executes the General Advertising Selection Program (“GASP”). For non-registered buyers, GASP identifies the default advertising at the top of the default advertising queue (S74b). For registered buyers, GASP selects advertising at least in part based on the buyer's past activity at BuyersDesire (S74a).

Step 5. (S75) The buyer's browser retrieves and displays the BuyersDesire homepage. This page has the following key features: GASP-selected advertising; partner advertising (e.g., Kozmo.com for immediate gratification shopping); a prominent search box prompting the buyer to enter her “Desire” in natural language; links to information on helpful searching types; an explanation on how the search process works; tips on shopping safely, and other similar information; “Browse” links that allows the buyer to scan products and services currently in the BuyersDesire database; a link to a Web search engine (e.g., Yahoo, Excite); links that allow the user to “Login,” “Register with BuyersDesire,” learn “About BuyersDesire,” “Contact” BuyersDesire, and “Change Account Preferences”; a “View Saved Searches” link if the buyer has any saved searches; and a “View Seller Offers” link if the buyer has saved searches to which sellers have made offers.

For registered buyers, the buyer is greeted by name on the display.

### EXAMPLE 2

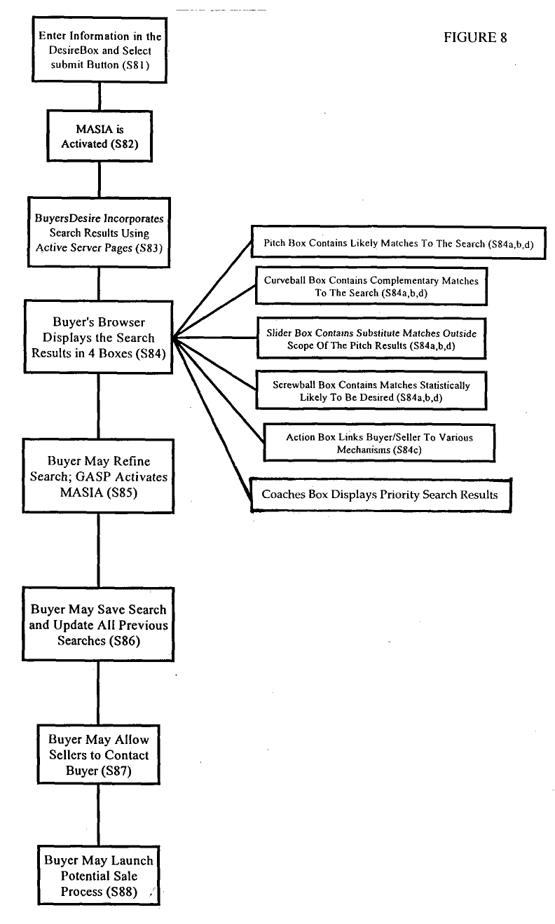

### Use of the Buyer's Purchase Request Module on a Computer Network (FIG. 8)

Step 1. (S81)The buyer enters as much detail as desired or known in “natural language” about a product or service in the Desire Box located on the Web page. If the buyer is refining a previously run search, the original search description appears in the Desire Box where the buyer can edit the search parameters. The buyer's description may or may not include price details. The search process continues when the buyer selects the submit button.

Step 2. (S82) The BuyersDesire host server runs a suite of search applications, e.g., using the MASIA search engine, which returns (i) targeted advertising, (ii) likely matches to the buyer's search, (iii) complementary and substitute products to the goods and services matching the buyer's search, (iv) goods and services identified as statistically likely to be desired by the buyer that neither match the buyer's search nor qualify as a complement or substitute to buyer's search, and (v) links to sites providing information that may help the buyer find the most appropriate product or service.

Step 3. (S83) The BuyersDesire host server incorporates the results into the search results page (e.g., a page written using Active Server Pages).

Step 4. (S84) The buyer's Internet browser displays the targeted advertising, the product (or service) search results, and the information site search results. The product (or service) search results are displayed in four boxes: the Pitch Box, the Curveball Box, the Slider Box and the Screwball Box. The browser displays up to five priority information site search results, chosen according to criteria established in conjunction with companies paying BuyersDesire for priority treatment of their product and service information web sites, in the Coaches' Box as well as a link to another page with the remaining sites that provide useful product selection information. The search results page also contains options for the buyer to refine her search, save her search, and to allow sellers to contact her with offers. The save search and seller contact options are displayed in the Action Box.

Step 4a. (S84a) The Pitch Box contains likely matches to the buyer's search. The Curveball Box contains complementary products to the goods or services matching the buyer's search. The Slider Box contains substitute products for the goods or services in the Pitch Box, but outside the specified scope of the buyer's search. The Screwball Box contains goods and services identified as statistically likely to be desired by the buyer that neither match the buyer's search nor qualify as a complement or substitute to buyer's search.

Step 4b. (S84b) Each item displayed in the Pitch Box, Curveball Box, Slider Box, and Screwball Box includes: (i) a product (or service) name; (ii) a description of the product or service; (iii) the name of each seller; (iv) seller contact information (e.g., usually a link to the seller's site); (v) an indicator of the seller's participation in one of BuyersDesire's guarantee programs; (vi) and price information where available.

Step 4c. (S84c) The Action Box is below the Pitch Box. It contains two links that will allow the buyer to save her search and allow sellers to contact the buyer through various mechanisms including: (i) telephone, (ii) e-mail, (iii) traditional mail, or (iv) one of the BuyersDesire search results boxes (Pitch Box, Curveball Box, Slider Box, Screwball Box, and Coaches Box) on subsequent visits by the buyer. These options will require the buyer to register with BuyersDesire so that the buyer can retrieve the saved search and any offers from sellers who have sought to contact the buyer through one of the BuyersDesire search results boxes.

Step 4d. (S84d) On the Pitch Box, the Curveball Box, the Slider Box, and the Screwball box, the buyer has the option to browse the results in serial fashion. If the buyer selects this option, the buyer's browser opens a new window and downloads, if necessary, an applet from the host server that will control the browsing process. The buyer then can step through each result by using the “Next result” and “Previous result” options as well as the “First result” option. The buyer also can choose to “Eliminate result” from the browsing sequence so that she can narrow the field of possible purchases.

Step 5. (S85) If the buyer chooses to refine her search by selecting the “Refine Search” link, the host server retains the buyer's search description. The buyer's browser redisplays the BuyersDesire homepage and the process repeats beginning with Step 1. GASP will call the advertising component of the MASIA suite of applications to generate targeted advertising on the homepage based on the initial search.

Step 6. (S86) If the buyer chooses to save her search by selecting the “Save Search” link, the host server retains the buyer's search description. The buyer's browser opens a new window—leaving the search results window open—and displays the save search page. The save search page will contain all past saved searches, including the new search, and present the buyer with options to view, delete, or modify saved searches as well as view offers by sellers who have responded to saved searches though the buyer's Pitch Box.

Step 7. (S87) If the buyer chooses to allow sellers to contact the buyer regarding the buyer's request, the buyer will be prompted to first save the search. If the buyer confirms that she wishes the search to be saved, then the process continues with Step 6 as if the buyer selected “Save Search”.

Step 8. (S88) If the buyer selects one of the search results that has a hyperlink, the potential sale process is launched in a new window. The BuyersDesire search results page remains open.

### EXAMPLE 3

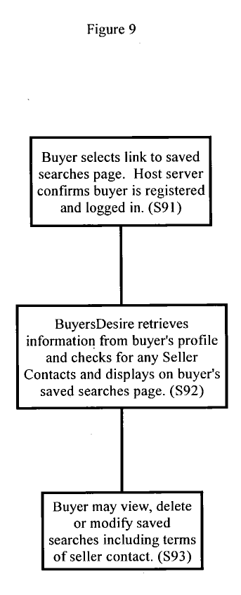

### Viewing and Modifying the Saved Searches Page (FIG. 9)

Saved searches allow sellers to contact buyers who may be interested in their products. In turn, saved searches allow buyers to examine offers from sellers without disclosing any personal information (unless they wish to disclose that information). A buyer can revisit a saved search more easily than re-entering it upon each visit.

Step 1. (S91) When the buyer selects a link to her saved searches page or selects the “Save this Search” option, her browser retrieves that page from the host server. Before releasing the page, the host server first confirms that the buyer is registered and logged-in. If not, the host server redirects the buyer's browser to the login page.

Step 2. (S92) The BuyersDesire host server next retrieves the save search language from the buyer's profile as well as the date and time of the save searches. This catalogue of saved searches includes the current search if the buyer has selected the “Save this Search” option. The host server also checks the “Seller Contact” database to see whether or not any sellers have contacted the buyer through one of the BuyersDesire search results boxes or the buyer's e-mail account and, for one of the BuyersDesire search results boxes, whether or not the buyer has not viewed any of those contacts. The host server HTML encodes this information for display on the buyer's saved searches page.

Step 3. (S93) The buyer's browser displays her saved searches page. Checkboxes allow the buyer to view, delete, or modify any of the saved searches. The buyer also can modify the terms of seller contact for each of the saved searches. The buyer can change the method of contact (Pitch Box, e-mail, telephone, or traditional mail) as well as the time frame during which sellers can contact the buyer regarding each of the saved changes. Using this feature, the buyer can halt seller contact through one of the BuyersDesire search results boxes and eliminate the ability of search sellers to detect the buyer's search request. Finally, by clicking on any of the saved searches, the host server will re-run the search and display the results augmented with seller contacts in the appropriate search result box (Pitch Box, Curveball Box, Slider Box, Screwball Box, and Coaches Box).

### EXAMPLE 4

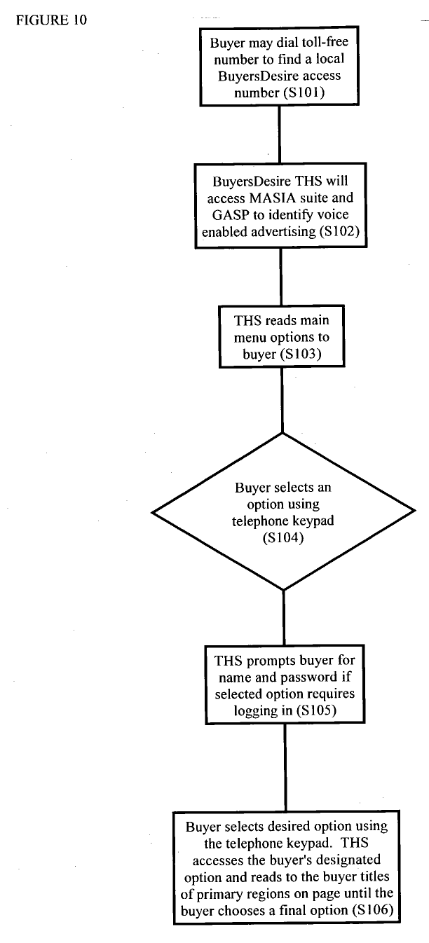

### Accessing Buyersdesire Service Using a Voice Telephony Device (FIG. 10)

BuyersDesire bridges the gap between the auditory and visual world of the Internet and the tactile and experiential world in which people live by making its resources available to anyone with a telephone. Buyers can harness the power of BuyersDesire while driving down the road, from an airplane, in a store shopping for a product, or negotiating with a service provider. While telephony access lacks some of the ease of use made possible by a Web browser's graphical interface and some BuyersDesire features are unavailable, a buyer still can access e-mail as well as search for her desires and price compare among different e-tailers and retailers.

Step 1. (S101) If the buyer does not know the local BuyersDesire access number, she can dial a toll-free number to find one. If a local number if not available, the buyer can access BuyersDesire through a long-distance telephone number.

Step 2. (S102) Throughout the telephony call, the BuyersDesire telephony host server (“THS”) will access the MASIA suite and GASP application to identify voice-enabled advertising. The advertising clips will be very short. The buyer can use the keys (or voice commands) to (i) find out more about the offer, (ii) delay learning more about the offer until the end of the call, (iii) save the offer to their Saved Searches at BuyersDesire where it can be reviewed later over the Internet, or (iv) ignore the advertisement.

Step 3. (S103) After reaching the telephony host server, the THS reads to the buyer the main menu options: (1) Facilitate Shopping Screen, (2) Search, (3) Saved Searches, (4) E-mail, (5) Accessing Other Voice Services, and (6) Help.

Step 4. (S104) The buyer selects one of these options using the telephone keypad.

Step 5. (S105) If the buyer has selected an options requiring login, the THS prompts the buyer for her buyer name and password.

Step 6. (S106) The basic operation for any choice is the same. The THS accesses the designated page content, retrieving buyer specific information if necessary. The THS then reads to the buyer the titles of primary regions on the page (e.g., for search results, (1) Pitch Box, (2) Curveball Box, (3) Slider Box, (4) Screwball Box, and (5) Coaches Box). The buyer selects the desired option using the telephone keypad. The process repeats itself for the next page until the buyer chooses a final option, presses “*” to go up a page, or presses “#” to return to the main menu.

### EXAMPLE 5

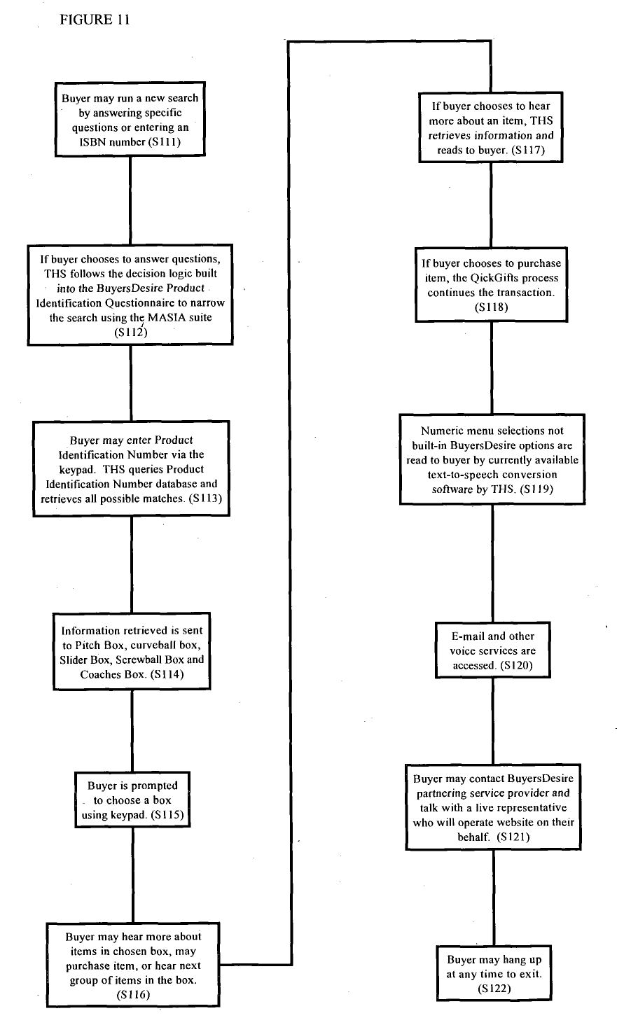

### Conducting a Search Using a Telephone (FIG. 11)

Step 1. (S111) If the buyer chooses to run a new search (i.e., not a saved search or a desire description saved in the Facilitated Telephony Shopping page), the THS gives the buyer two options for creating a search term: (1) the buyer can answer a series of increasingly specific questions aimed at identifying a product/service or category of product/service; or (2) the buyer can enter a product identification number (eg., serial number, ISBN number) and then identify the target product from a list of potential matches.

Step 2. (S112) If the buyer chooses to answer a series of questions, the THS follows the decision logic built into the BuyersDesire Product Identification Questionnaire. When the buyer answers a question using the keypad, the THS then retrieves and reads the next question specified by the Questionnaire given the previous answers received. Once the buyer has answered a sufficient number of questions for the THS to run a sufficiently narrow search using the MASIA suite, the buyer is given the option of executing the search or further narrowing the search criteria by answering another question (unless the questions have been exhausted).

Step 3. (S113) If the buyer chooses to enter a product's identification number, the buyer does so using the keypad. The THS then queries the Product Identification Number database and retrieves all possible matches. The THS reads the possible matches to the buyer in groups of eight until the buyer indicates a match.

Step 4. (S114) The THS set the language specified by the BuyersDesire Product Identification Questionnaire or the product name as the desire description. The THS then calls the MASIA suit, which returns the information for the Pitch Box, the Curveball Box, the Slider Box, the Screwball Box, and the Coaches Box.

Step 5. (S115) The THS prompts the buyer to choose one of the boxes using the keypad.

Step 6. (S116) The THS then reads the items in the selected box in groups of eight. The buyer can choose to: (1) hear more about the item; (2) purchase the item; or (3) hear the next group of items in the box.

Step 7. (S117) If the buyer chooses to hear more about a item, the THS retrieves the corresponding information (eg., for a product/service, the THS retrieves from the BuyersDesire Product Database the description) and reads it to the buyer. The THS reads the text information to the buyer using currently available text-to-speech conversion software.

Step 8. (S118) If the buyer chooses to purchase one of the items generated by the search, the THS then prompts the buyer to: (i) automatically send an item using the default shipping and billing information; (ii) hear a description of the item; or (iii) to choose among different payment, address, and wrapping options. If the buyer selects the automatic send option, the THS executes the Automatic Selection application, providing it with the selected item. If the buyer chooses to alter the default information, the THS reads the available addresses and wrapping options to the buyer. The THS also prompts the buyer to select a stored payment option or to enter credit card information using the keypad. When this process is complete, the THS sends the gift choice, payment, wrapping, and address information to the Automatic Selection application. The THS sends an e-mail message to the designated e-mail address with the details of the transaction. The THS confirms all sales requests with the buyer before finalizing the transaction.

Step 9. (S119) For numeric menu selections that are not built-in BuyersDesire numeric menu options (eg., the names of items retrieved by the Automatic Selection application), the THS uses text-to-speech conversion software to read the options to the buyer.

Step 10. (S120) E-mail and other voice services are accessed using voice Internet technology (eg., services available form Genmagic.com and Phone.com).

Step 11. (S121) The buyer can avoid many of the inconveniences associated with telephony access by contacting a BuyersDesire partnering service provider who has live representatives that will talk with the buyer and operate the BuyersDesire website on their behalf.

Step 12. (S122) The buyer can exit a telephony BuyersDesire session at any time by hanging up.

### EXAMPLE 6

### Searching the Buyer's Database

Sellers can find potential buyers for their products/services by going to SellersDesire.com or by selecting the “Seller Search” option on the BuyersDesire homepage. SellersDesire.com works much the same as the BuyersDesire website, including the use of targeted advertising (since the sellers are people, the advertising will be tailored to them personally as well as to their business, if known). The seller can search and save searches (stored in the BuyersDesire Seller Profile Database). The seller may choose to have its saved searches treated as automated searches or simply stored for future use.

The seller initiates a search by entering a description of the product or service it has to offer in the Desire Box. The host server calls the MASIA suite and provides the seller with a list of probable matches including any statistical information available on the potential buyer (eg., the buyer's desire description, lowest price and item currently returned to the buyer, lowest price for the item specified by the seller returned to the buyer, how to contact the buyer). If the seller selects one of the search results, the host server returns the complete set of information available on that buyer and provides a form for the seller to contact the buyer if the buyer has chosen the either contact by e-mail or contact by Box (Pitch Box, Curveball Box, Slider Box, or Screwball Box) option. The host server processes the sellers contact information and either sends the buyer an e-mail or updates the buyer's profile in the Buyer Profile database.

While preferred embodiments have been specifically described and illustrated herein, it should be apparent that many modifications to the embodiments and implementations of the invention can be made without departing from the spirit or scope of the invention. For example, while the preferred embodiments illustrated herein utilize a client-server architecture that provides a user interface for Buyers and Sellers in the form of a Web site, it should be readily apparent that any architecture and user interface may be implemented. The computer terminal 102 illustrated in FIG. 1 may take the form of a personal computer, mainframe computer, thin-client device, WebTV (or other Internet- only) terminals, set-top boxes, screenphones, kiosks, or other known communication devices. Although the preferred embodiments have particular application to broad consumer markets, it should be readily apparent that the invention can easily be adapted to a narrower scope of users such as business-to-business (B2B) transactions, individual corporation intranets, specific vertical markets, etc.

While the illustrated embodiments have been described utilizing Internet communications, it should be readily apparent that other communication systems or (wired/wireless) networks (e.g., intranets, private bulletin boards, individual local or wide area networks, proprietary chat rooms, ICQ, IRC channels, instant messaging systems, etc.) using real-time or non-real-time systems in lieu of or in addition to the disclosed Internet resources may also be utilized. Individual ones of a plurality of user interface client devices (e.g., network/stand-alone computers, personal digital assistants (PDAs), WebTV (or other Internet-only) terminals, set-top boxes, cellular/PCS phones, screenphones, pagers, kiosks, thin-client, or other known (wired or wireless) communication devices) execute one or more computer programs (e.g., specialized client software, standard Web browser software, etc.) to permit use of the host service (e.g., Web site).

Although MASIA 122 (FIG. 1) is shown and described as executing search queries using data stored on databases 124, it should be apparent that MASIA 122 may operate to search the Internet and any other information resource available in lieu of or in conjunction with databases 124.

The individual method steps of the exemplary operational flows specifically illustrated in (or inherent from) those depicted in FIGS. 5-11 may be interchanged in order, combined, omitted, replaced or even added to without departing from the scope of the invention. Any number of different operations not illustrated herein may be performed utilizing the invention.

The modules described herein such as the modules making up system 200, host server 120, MASIA search engine 122, databases 124, modules 132, 134, 136, 138, and processor-based system 12, may be one or more hardware, software, or hybrid components residing in (or distributed among) one or more local or remote systems. It should be readily apparent that the modules may be combined within their subsystems (e.g., host server 120, MASIA 122, and databases 124) or further separated into a variety of different components, sharing different resources (including processing units, memory, clock devices, software routines, etc.) as required for the particular implementation of the embodiments disclosed herein. The subsystems themselves (e.g., host server 120, MASIA 122, and databases 124) may be combined together or further separated as required for implementation. Indeed, even a single general purpose computer executing a computer program stored on a recording medium to produce the functionality referred to herein may be utilized to implement the illustrated embodiments. Thus, although the preferred embodiments described in detail herein utilize a client-server architecture communicating over network systems, the apparatus (and methods of the invention) may be adapted for use on stand-alone systems such as personal computers, hand-held electronic devices (e.g., cellular phone, personal digital assistant device (“PDA”), etc.), a pager or any other device having equivalent structure or performing the equivalent acts described herein.

Furthermore, memory units employed by the system, including those in databases 124, may be any one or more known storage devices (e.g., Random Access Memory (RAM), Read Only Memory (ROM), hard disk drive (HDD), floppy drive, zip drive, compact disk-ROM, DVD, bubble memory, etc.) or systems (e.g., Redundant Array of Independent Disks (RAID), etc.). These memory units may also be one or more memory devices embedded within a CPU, or shared with one or more of the other components. Accordingly, the invention is not to be seen as limited by the foregoing description, but is only limited by the scope of the appended claims. The computer programs or algorithms described herein may easily be configured as one or more hardware modules, and the hardware modules shown may easily be configured as one or more software modules without departing from the invention. Accordingly, the invention is not limited by the foregoing description, drawings, or specific examples enumerated herein, but only by the appended claims.

1. A system for fulfilling a buyer's purchase request comprising:
a buyer's purchase request module;
a buyer's search display module; and
a sales processing module wherein a buyer may complete a transaction with a seller identified through said buyer's search display module.

2. A system for fulfilling a buyer's purchase request comprising:
a buyer's purchase request module;
a seller's search function module;
an offer display module; and
a sales processing module wherein a buyer can complete a transaction with a seller presenting an offer through said buyer's search display module.

3. A system for fulfilling a buyer's purchase request comprising:
a processing unit; and
a memory, wherein a computer program is stored in said memory for execution by said processing unit to enter a buyer's request into a buyer's purchase request module; to conduct a search using a Matches Module, an Alternatives and Complements Module, a Statistical Alternatives Module, an Information Selection Module, and an Advertisement Selection Module; and display the results of said search in a plurality of results boxes selected from the group consisting of a Pitch Box, a Curveball Box, a Slider Box, and a Screwball Box.

4. The system of claim 1 further comprises a seller's program.

5. The system of claim 2 further comprising a seller's program.

6. The system of claim 1 wherein said buyer's purchase request module further comprises a natural language search engine.

7. The system of claim 2 wherein said buyer's purchase request module further comprises a natural language search engine.

8. The system of claim 1 wherein said buyer's search display module provides a plurality of result boxes.

9. The system of claim 2 wherein said offer display module provides a plurality of result boxes.

10. The system of claim 7 wherein said result box provides at least a product name, a product description, a seller name, a seller contact and an indication as to whether a seller participates in a seller program.

11. The system of claim 8 wherein said result box provides at least a product name, a product description, a seller name, a seller contact and an indication as to whether a seller participates in a seller program.

12. The system of claim 1 wherein said buyer's search display module further comprises an action box, a matches box, a complements box, a statistical alternatives box and an advertisements box.

13. The system of claim 2 wherein said offer display module further comprises an action box, a matches box, a complements box, a statistical alternatives box and an advertisements box.

14. The system of claim 7 wherein said result boxes provides at least a product name, a product description, a seller name, a seller contact and an indication as to whether a seller participates in a seller program.

15. The system of claim 8 wherein said result boxes provides at least a product name, a product description, a seller name, a seller contact and an indication as to whether a seller participates in a seller program.

16. The system of claim 4 wherein said seller's program comprises an escrow service.

17. The system of claim 4 wherein said seller's program comprises an escrow service.

18. The system of claim 4 wherein said seller's program comprises a bonding service.

19. The system of claim 4 wherein said seller's program comprises a bonding service.

20. The system of claim 11 wherein said action box permits a buyer to indicate seller contact preferences.

21. The system of claim 12 wherein said action box permits a buyer to indicate seller contact preferences.

22. The system of claim 19 wherein said seller contact preferences further comprise a save search function and contact option function.

23. The system of claim 20 wherein said seller contact preferences further comprise a save search function and contact option function.

24. The system of claim 21 wherein said save search function permits a buyer to save a plurality of said buyer's purchase requests.

25. The system of claim 21 wherein said contact option function permits a buyer to request a seller contact said buyer by at least one method selected from the group consisting of a telephone, e-mail, traditional mail, or a buyer's search display module.

26. The system of claim 11 wherein said matches box provides matches to a buyer's purchase request.

27. The system of claim 11 wherein said complements box provides complementary goods or services related to a buyer's purchase request.

28. The system of claim 11 wherein said statistical alternatives box provides goods or services statistically likely to be desired by a buyer.

29. The system of claim 11 wherein said advertisements box provides targeted advertising.

30. The system of claim 11 wherein said action box further comprises a Wish List Module.

31. The system of claim 12 wherein said action box further comprises a Wish List Module.

32. The system of claim 11 wherein said action box further comprises a Buyer's Preference Module.

33. The system of claim 12 wherein said action box further comprises a Buyer's Preference Module.

34. The system of claim 11 wherein said action box further comprises a Custom Catalog Module.

35. The system of claim 12 wherein said action box further comprises a Custom Catalog Module.

36. A method of fulfilling a buyer's request comprising:
entering a buyer's request into a buyer's purchase request module;
conducting a search of said buyer's purchase request using a seller's search function module;
providing offers to a buyer using an offer display module wherein a buyer can complete a transaction with a seller using a sales processing module.

37. A method of fulfilling a buyer's request comprising:
entering a buyer's request into a buyer's purchase request module;
conducting a search using a Matches Module, an Alternatives and Complements Module, a Statistical Alternatives Module, an Information Selection Module, and an Advertisement Selection Module;
displaying the results of said search in a plurality of results boxes selected from the group consisting of a Pitch Box, a Curveball Box, a Slider Box, and a Screwball Box wherein a buyer can complete a transaction with a seller using a sales processing module.

38. An article of manufacture comprising a machine-readable storage medium having stored therein indicia of a plurality of machine-executable control program steps, the control program comprising the steps of:
entering a buyer's request into a buyer's purchase request module;
conducting a search using a Matches Module, an Alternatives and Complements Module, a Statistical Alternatives Module, an Information Selection Module, and an Advertisement Selection Module;
displaying the results of said search in a plurality of results boxes selected from the group consisting of a Pitch Box, a Curveball Box, a Slider Box, and a Screwball Box wherein a buyer can complete a transaction with a seller using a sales processing module.

39. An article of manufacture comprising a machine-readable storage medium having stored therein indicia of a plurality of machine-executable control program steps, the control program comprising the steps of:
entering a buyer's request into a buyer's purchase request module;
conducting a search of said buyer's purchase request using a seller's search function module;
providing offers to a buyer using an offer display module wherein a buyer can complete a transaction with a seller using a sales processing module.
